(19) United States
(12) Patent Application Publication
(10) Pub. No.: US 2013/0163568 A1
(43) Pub. Date: Jun. 27, 2013

(54) METHOD AND SYSTEM FOR RESOURCE ALLOCATION IN DISTRIBUTED TIME-DIVISION MULTIPLEXING SYSTEMS

(71) Applicants: Shu-Hsin CHANG, Tainan City (TW); Jui-Wen Chen, Kaohsiung City (TW); Wei-Chih Ting, Taichung City (TW)

(72) Inventors: Shu-Hsin CHANG, Tainan City (TW); Jui-Wen Chen, Kaohsiung City (TW); Wei-Chih Ting, Taichung City (TW)

(73) Assignee: Industrial Technology Research Institute, Hsinchu (TW)

(21) Appl. No.: 13/589,621

(22) Filed: Aug. 20, 2012

(30) Foreign Application Priority Data
Dec. 26, 2011 (TW) 100148640

(51) Int. Cl. H04J 3/16

(52) U.S. Cl. 370/336

(57) ABSTRACT

In one exemplary embodiment, a system for resource allocation in a distributed time-division multiplexing (TDM) system comprises a plurality of users with each user having a corresponding weight and taking turns to use the resources of the distributed TDM system. The each user repeats the execution of obtaining a resource usage right, reading a first message of a user having an active weight sum and a system benefit level; computing a resource usage quantity of the user, computing a resource residual quantity of the user, updating the active weight sum, and storing an individual benefit basis of the user; dividing the resource residual quantity by an updated value of the active weight sum and accumulating a divided result to the system benefit level; and transferring a second message having the updated value of the active weight sum and an accumulated value of the system benefit level to a next user obtaining the resource usage right.

### CROSS-REFERENCE TO RELATED APPLICATION

The present application is based on, and claims priority from, Taiwan Application No. 100148640, filed Dec. 26, 2011, the disclosure of which is hereby incorporated by reference herein in its entirety.

### TECHNICAL FIELD

The present disclosure generally relates to a method and system for resource allocation in distributed time-division multiplexing (TDM) systems.

### BACKGROUND

Max-min fairness principle is one of the most widely adopted concepts of resource allocation in the present TDM systems. According to the max-min fairness principle, the system may fairly allocate resources with a proportion according to the weights and requirements of users, make full use of the system resources by reallocating the residual resources released from the satisfied users, and provide each user a predicable minimum resource usage quantity and maximum service latency. The features of the max-min fairness principle may include high resource accessibility, high flexibility to demand variation, and high reliability of service quality. Max-min fairness principle may be applied to resource allocation in distributed TDM systems, such as bandwidth allocation of ad-hoc network, mesh network, wireless LAN, wireless sensor network, and token ring network, etc., and task scheduling in a central processing unit (CPU).

One mode of resource allocation for TDM systems is an interleaved polling-based scheme. In this mode, all users take turn to use system resources with a round-robin manner. A system service cycle may be defined as a continuous period of a service round taking any user as a starting point. For example, in a process of 10 users sharing resources in a round-robin manner, the service cycle may be a continuous period of resource usage from user 1 to user 10, or it may be a continuous period of resource usage from user 5 to user 10, added with a continuous period of resource usage from user 1 to user 4. This mode may individually calculate resource usage quantity according to a requirement of a single user, instead of allocating resources for an entire service cycle after gathering the requirements of all of the users.

There are many well-known resource allocation algorithms such as limited service scheme, elastic service scheme, and so on. According to the limited service scheme, initially, a system may set a maximum service quantity for each user respectively, according to a weight ratio. Then, all users use the system resources in a round robin manner. The resource usage quantity obtained by each user in any round is the minimum of the resource demand quantity and the maximum service quantity. FIG. 1 shows an exemplar for resource allocation based on the limited service scheme. In this exemplar, it is assumed that three users share the resources of a network system. The upper portion of the figure illustrates the case of a standard resource allocation defined in accordance with maximum services quantity, while the lower portion of the figure illustrates the resource allocation result calculated by referring to the actual demands of users. In the upper figure, after a user i receives a message Tᵢ to obtain a bandwidth usage right, user i starts to transmit data Dᵢ, then transfers the message Tᵢ₊₁ to the next user i+1 before the end of an exclusive resource usage duration of the user i. There is a transition gap retained for each switching point of the data and message transmission time.

In the lower figure, it is assumed that the demand quantity of user 1 and user 2 continues to be 0, and user 3 continues to request an extremely high demand quantity. According to the resource usage quantity defined in this scheme, the usage quantity of user 1 and user 2 are all 0, and the usage quantity of user 3 is a fixed maximum service quantity. It may be seen from the exemplar, when the demand quantities of most users are relatively low, the overhead of switching resource usage right among users is accordingly increased. Here the overhead includes the message transmission time and the retained transition gaps. This situation leads to a low resource utilization of the system, and a great amount of power consumption in the transceiver.

According to the elastic service scheme, initially, a system may set a maximum cycle service amount, and all users use the system resources in a round robin manner. The resource usage quantity obtained by each user in any round is the minimum of the resource demand quantity and the residual service amount in a current cycle. FIG. 2 shows an exemplar for resource allocation of the elastic service scheme. In this exemplar, it is assumed that three users share the system resources. The upper figure shows a standard resource allocation, and the lower figure shows a resource allocation result calculated by referring to the actual demands of users. In the lower figure, it is assumed that the demand quantity of user 2 and user 3 are all 0, and user 1 requests an extremely high demand quantity in the first cycle. According to the resource usage quantity defined in this scheme, the obtained usage quantities of user 2 and user 3 are all 0, while the usage quantity of user 1 is the maximum cycle service amount.

Hereafter, starting from the second cycle, it is assumed that all users request extremely high demand quantities. According to the definition of resource usage quantity, for user 1, the resource usage quantities of user 2 and user 3 in the previous cycle are all 0, thus the usage quantity obtained by user 1 is still the maximum cycle service amount; for user 2, since the total usage quantity of user 3 and user 1 in the previous cycle has reached the maximum cycle service amount, the usage quantity of user 2 is still 0. Similarly, for user 3, the obtained usage quantity is also 0. Therefore, as long as user 1 continues to request extremely high demand quantities, the system will always satisfy user 1 with an absolute priority, and ignore the demands of user 2 and user 3 at all. This situation leads to an unfairness of resource allocation, and the system may not guarantee the service quality to each user.

Distributed fair scheduling scheme is a representative resource allocation scheme applied in a distributed system. The distributed fair scheduling scheme is based on a carrier sense multiple access with collision avoidance (CSMA/CA) mechanism under the distributed coordination function (DCF) mode of the IEEE802.11 MAC protocol, and introduces formulas of a self-clock fair queuing (SCFQ) scheduling algorithm to set a backoff interval for each packet transmission according to a weight ratio. When a packet collision occurs, this scheme exponentially increases the backoff interval according to the times of collisions. This scheme also employs an exponential mapping method to compensate for the shortcomings of high packet collision probability and low bandwidth utilization.

In a distributed TDM system, a good resource allocation scheme should be able to achieve a high utilization of system resources and guarantee the service quality for each user, and simultaneously have a low computational complexity. The resource allocation scheme is an important research issue and has been continuously in-depth explored.

### SUMMARY

The exemplary embodiments of the present disclosure may provide a method and system for resource allocation in distributed time-division multiplexing (TDM) systems. In the following exemplary embodiments, the resource usage quantity is defined as resource quantity obtained by each individual user in every turn of resource allocation, and the resource amount is defined as an amount of resources provided by the system, wherein the resource amount of the system is the sum of the resource usage quantity of each user and the resource quantity occupied by overhead.

One exemplary embodiment relates to a method for resource allocation in a distributed time-division multiplexing (TDM) system. The distributed TDM system consists of a plurality of users and one or more resources, with each user having a weight. The resource allocation method comprises: reading a first message via a user obtaining a resource usage right of the plurality of users, wherein the first message containing an active weight sum and a system benefit level; calculating a resource usage quantity of the user, calculating a resource residual quantity of the user, updating the active weight sum, and storing an individual benefit basis of the user; dividing the resource residual quantity by an updated value of the active weight sum and accumulating a divided result to the system benefit level; transferring a second message containing the updated value of the active weight sum and an accumulated value of the system benefit level to a next user obtaining the resource usage right; and repeating the above all steps to allocate resources of the distributed TDM system.

Another exemplary embodiment relates to a system for resource allocation in a distributed time-division multiplexing (TDM) system. The system for resource allocation comprises a plurality of users with each user having a weight and taking turns to use resources of the distributed TDM system. The each user repeats the execution of: obtaining a resource usage right, and reading a first message of a user having an active weight sum and a system benefit level; computing a resource usage quantity of the user, computing a resource residual quantity of the user, updating the active weight sum, and storing an individual benefit basis of the user; dividing the resource residual quantity by an updated value of the active weight sum and accumulating a divided value of the resource residual quantity to the system benefit level; and transferring a second message having the updated value of the active weight sum and an accumulated value of the system benefit level to a next user obtaining the resource usage right.

The foregoing and other features and aspects of the disclosure will become better understood from a careful reading of a detailed description provided herein below with appropriate reference to the accompanying drawings.

### BRIEF DESCRIPTION OF THE DRAWINGS

FIG. 1 shows an exemplar for resource allocation based on the limited service scheme.

FIG. 2 shows an exemplar for resource allocation based on the elastic service scheme.

FIG. 3 shows a schematic view of allocating resources in accordance with a weighted max-min fairness principle, according to an exemplary embodiment.

FIG. 4 shows a schematic view of controlling a progress offset of an actual resource usage relative to a standard resource usage, according to an exemplary embodiment.

FIG. 5A shows an application scenario for resource allocation of a distributed TDM system based on per-node fairness, according to an exemplary embodiment.

FIG. 5B shows an application scenario for resource allocation of a distributed TDM system based on per-flow fairness, according to an exemplary embodiment.

FIG. 5C shows another application scenario for resource allocation of a distributed TDM system based on per-flow fairness, according to an exemplary embodiment.

FIG. 6 shows an exemplary architecture for a resource allocation system applied in a distributed TDM system, according to an exemplary embodiment.

FIG. 7 shows the operation of a resource allocation method applied in a distributed TDM system, according to an exemplary embodiment.

FIG. 8 shows a flow chart of calculating a resource usage quantity of a user, according to an exemplary embodiment.

FIG. 9 shows a flow chart of calculating a resource residual quantity of a user for resource allocation based on per-flow fairness, according to an exemplary embodiment.

FIG. 10 shows a flow chart of updating an active weight sum for resource allocation based on per-flow fairness, according to an exemplary embodiment.

FIG. 11 shows a numerical exemplar for resource allocation based on the per-node fairness mode, according to an exemplary embodiment.

FIG. 12 shows a numerical exemplar for resource allocation based on the per-flow fairness mode, according to an exemplary embodiment.

FIG. 13 shows an exemplar for a definition of constant notations and variable notations, according to an exemplary embodiment.

FIG. 14 shows an exemplar of calculating the resource usage quantity of each user through the notation definition, according to an exemplary embodiment.

FIG. 15 shows a resource allocation procedure expressed by the physical quantities and operations with consideration of a progress offset limit of the resource usage, according to an exemplary embodiment.

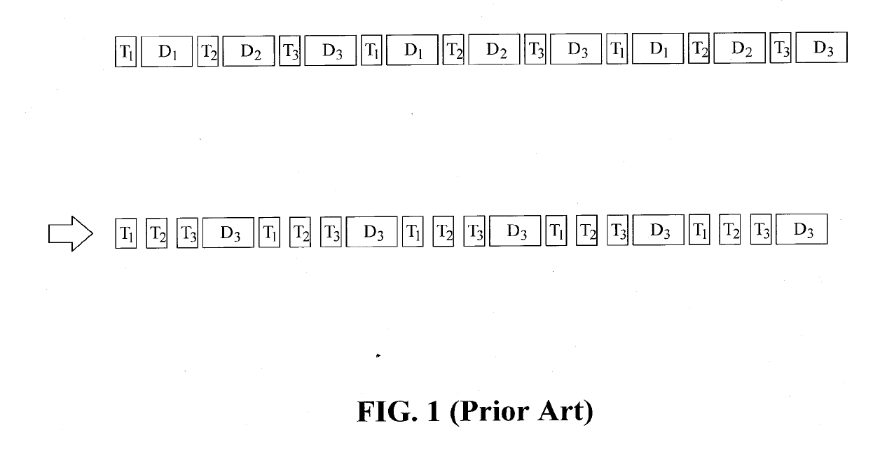

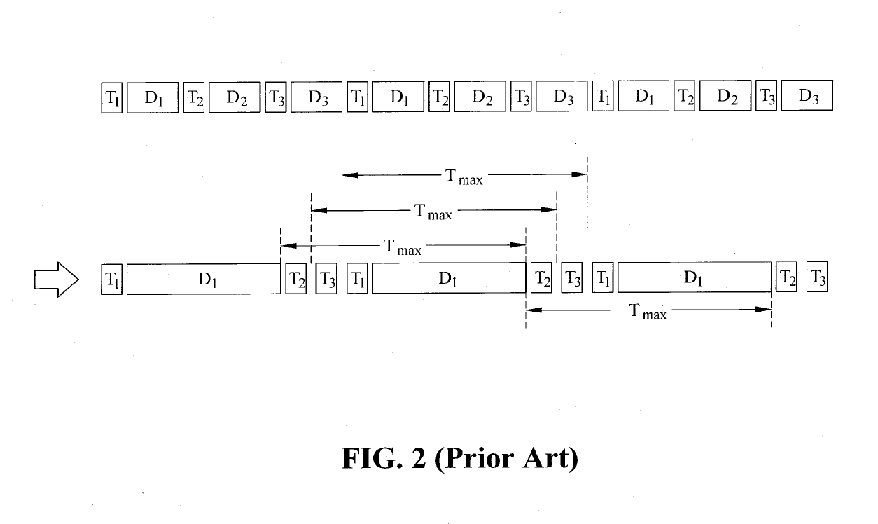

### DETAILED DESCRIPTION OF DISCLOSED EMBODIMENTS

The exemplary embodiments in the disclosure aim to a resource allocation scheme in distributed time-division multiplexing (TDM) systems. A distributed TDM system consists of a plurality of users and one or more resources. Each user takes turns to calculate a resource usage quantity for itself, and use each of the one or more resources according to the resource usage quantity. For each of the resources, at most one user is allowed to exclusively use such resource at any time point.

The design of the disclosure applied to resource allocation in a distributed TDM system uses a standard ruler as a basis of allocating a resource usage quantity, defines a basic resource usage quantity of each user (hereinafter referred to as the basic quantity) based on this standard ruler, reallocates a resource residual quantity according to a weight ratio, and controls a progress offset of an actual resource usage relative to a standard resource usage. The disclosure maintains a set of resource management variables as a reference of calculating the resource usage quantity. When a user releases an amount of residual resources, the resource residual quantity is normalized and accumulated to a resource management variable; when a user requires extra resources, a cyclic increment of the resource management variable is multiplied by a weight of the user, and the obtained product is used to calculate a benefit quantity (an extra resource quantity in addition to the basic quantity) of the user. A set of public resource management variables are transferred along with a resource usage right among users. The user obtaining the resource usage right calculates its own resource usage quantity in a current services cycle, and maintains the status of this set of public resource management variables collaboratively. The following exemplary embodiments illustrate this resource allocation design in distributed TDM systems.

The resource allocation method of the disclosure uses a standard ruler as a basis of allocating a resource usage quantity, and determines a basic quantity for each user according to this standard ruler. The so-called standard ruler is obtained by deducting overheads from a predetermined standard cyclic resource amount to get a standard cyclic service amount, allocating the standard cyclic service amount to each user to serve as a standard resource allocation quantity according to a weight ratio, arranging the standard resource allocation quantity of each user and the overheads to form a standard resource allocation cycle, and consecutively repeating the standard resource allocation cycle to form a standard ruler. The so-called basic quantity is the standard resource allocation quantity obtained by each user within one standard resource allocation cycle.

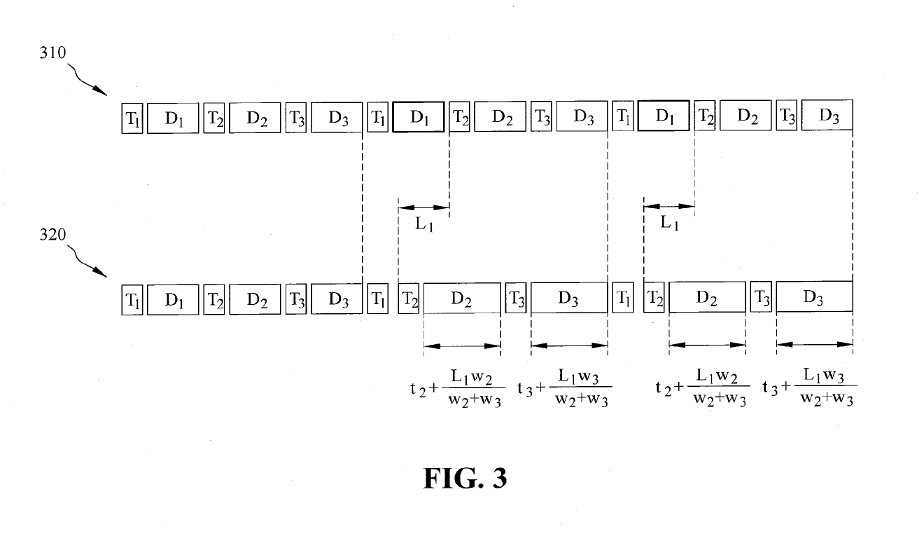

FIG. 3 shows a schematic view of allocating resources in accordance with a weighted max-min fairness principle, according to an exemplary embodiment. In the exemplar of FIG. 3, the resource allocation of the disclosure defines a basic quantity of each user in accordance with the standard ruler, and fairly allocates each resource residual quantity to the users having an active state, according to the weight ratio. Wherein the definition of a user state may be flexibly designed according to application demands. In the exemplary embodiments of the disclosure, if the latest demand quantity of a user is higher than the basic quantity of the user, then the user state is defined as active; otherwise the user state is defined as inactive. In addition, another definition of a user state may be as follows. If the latest demand quantity of a user is higher than the resource usage quantity obtained by the user (i.e. the user's need is not met), then the user state is active; otherwise the user state is inactive.

As shown in FIG. 3, a standard ruler 310 in the upper figure is used as a basis of allocating the resource usage quantity. The lower figure shows the result of resource usage quantity 320 according to resource allocation calculated by referring to the user demands. Assume that the number of users is 3, the weight of user i is wᵢ, and the basic quantity of user i is tᵢ. In the first cycle, the system resources are allocated to all users according to the basic quantity. Then, from the second cycle, the demand quantity of user 1 continues to be 0, and user 2 and user 3 continue to request extremely high demand quantities.

The resource allocation of the disclosure defines a basic quantity for each user based on the standard ruler, and reallocates the resource residual quantity according to the weight ratio. Therefore, each time when user 1 releases a resource quantity L₁ (assumes that L₁=t₁ in the exemplar), these residual resources are immediately reallocated to the succeeding user 2 and user 3. According to the weight ratio, the extra resource quantities allocated to user 2 and user 3, respectively, are τ₂=(L₁w₂)/(w₂+w₃) and τ₃=(L₁w₃)/(w₂+w₃). As such, starting from the second cycle, the resource usage quantity of user 2 is t₂+τ₂, and the resource usage quantity of user 3 is t₃+τ₃. This scheme conforms to the weighted max-min fairness principle, and the residual resources released from each user may be fully reallocated within one succeeding service cycle. Thus, aligned to a service switch point of user 1, the actual resource usage amount in each service cycle is the same as the standard cyclic resource usage amount. In other words, the average cyclic service amount of the system does not decrease as the variation of user demand quantities. Therefore, the overall resource utilization of the system is increased.

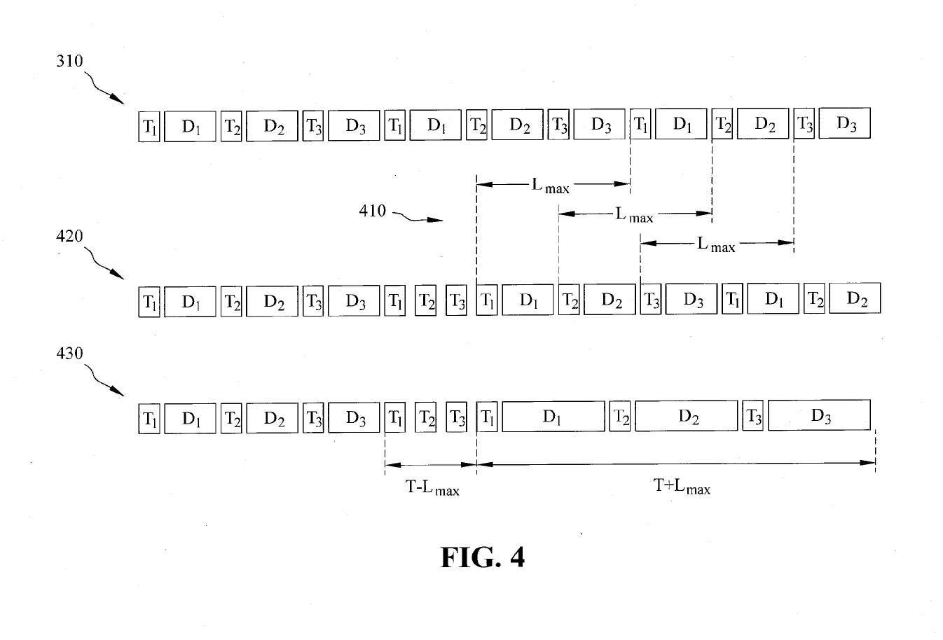

FIG. 4 shows a schematic view of controlling a progress offset of an actual resource usage relative to a standard resource usage, according to an exemplary embodiment. In the exemplar of FIG. 4, the resource allocation limits the progress offset of resource usage within a range not greater than a predefined maximum progress offset Lₘₐₓ, as indicated by an arrow 410 in FIG. 4. For the result of a resource usage quantity 420, aligned to any service switch point Tᵢ, the resource usage progress offset relative to the standard ruler 310 is upper limited by Lₘₐₓ. One approach to control the resource usage progress offset is to maintain a current progress offset L in a system, and enforce the resource usage quantity of each user i in every service cycle to be greater than or equals to tᵢ−(Lₘₐₓ−L). As such, aligned to any service switch point Tᵢ, the actual resource usage amount in each service cycle may be limited within a range of [T−Lₘₐₓ, T+Lₘₐₓ], where T is the standard cyclic resource amount.

For example, in the result of another resource usage quantity 430, aligned to the service switch point T₁, the actual resource usage amount in the second cycle is limited to not less than T−Lₘₐₓ. This may correspond to a case that the demand quantities of all users in the second cycle are 0. Comparatively, the actual resource usage amount in the third cycle is limited to not greater than T+Lₘₐₓ. This may correspond to a case that all users request extremely high demand quantities in the third cycle. Thus, by controlling the resource usage progress offset, the maximum latency each user waiting for the resources is guaranteed.

As mentioned above, the resource allocation based on the weighted max-min fairness principle may be applied to distributed TDM systems, such as the bandwidth allocation of ad-hoc network, mesh network, wireless local area network (WLAN), wireless sensor network, token ring network, etc., and the task scheduling of central processing units (CPU). Similarly, the disclosed resource allocation may also be applied to the above mentioned systems. Take the bandwidth allocation of a network system as an example, the network system may comprise a plurality of users, with each user having a corresponding weight. A user may be a data stream, a node, or a data queue corresponding to certain service level in a network, and may individually use the bandwidth of one or more channels within a dedicated time for data transmission. The user may determine the bandwidth demand quantity according to its data queue length. The overhead of resource allocation includes the bandwidth expended by massages and transition gaps. Take the task scheduling of a CPU as an example, the computational resources of the CPU may be shared by a plurality of users, and each user has a corresponding weight. A user may be a software program, a thread, or a task, and may individually use the computational resources of one or more processing cores in the CPU within a dedicated time. The user demand quantity is the amount of computational resources required to complete the task. The overhead is the computational resources occupied by a context switch routine. The exemplary embodiments of the disclosure respectively describe the resource allocation of per-node fairness and per-flow fairness, according to the primary application scenarios of distributed TDM systems.

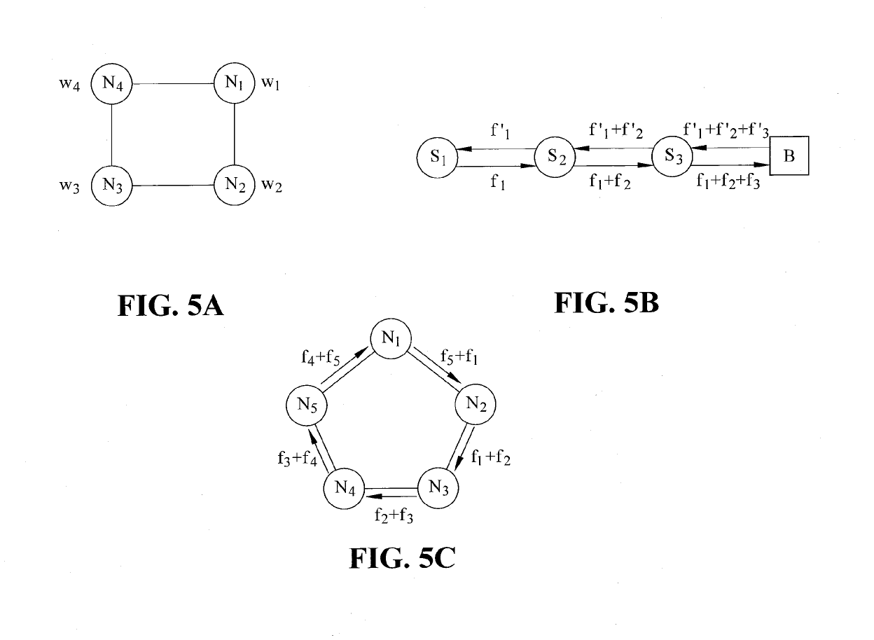

FIG. 5A shows an application scenario for resource allocation of a distributed TDM system based on per-node fairness, according to an exemplary embodiment. FIG. 5B shows an application scenario for resource allocation of a distributed TDM system based on per-flow fairness, according to an exemplary embodiment. FIG. 5C shows another application scenario for resource allocation of a distributed TDM system based on per-flow fairness, according to an exemplary embodiment.

In the application scenario of FIG. 5A, the disclosed resource allocation is applied to the bandwidth allocation of an ad-hoc network. The ad-hoc network consists of a plurality of nodes, such as four nodes N ₁˜N₄. Wherein each node N, may be regarded as a user, and takes turns to use the network bandwidth according to its weight wᵢ. The bandwidth usage quantity of each node conforms to the weighted max-min fairness principle.

In the application scenario of FIG. 5B, the disclosed resource allocation is applied to the bandwidth allocation of a mesh network. The mesh network comprises a plurality of subscribers (such as S1˜S3) and a base station B. The application scenario takes each data stream as a user, and arranges the transmission quantity of each data stream (fᵢ or fᵢ′) to conform to the weighted max-min fairness principle under the condition of data forwarding. A data stream from the upstream subscriber may be transferred to the base station B through the intermediate nodes. Thus, the transmission data of an intermediate subscriber contains the data generated by the intermediate subscriber and that from the upstream subscribers. Each data stream has a corresponding weight and a corresponding distance, wherein the distance is a positive integer indicating the number of nodes on the path from the source (included) to the destination (excluded). Each data stream uses the network bandwidth in accordance with its weight ratio.

In the application scenario of FIG. 5C, the disclosed resource allocation is applied to the bandwidth allocation of a token ring network. The token ring network comprises a plurality of nodes (such as N1˜N5). Herein each data stream is treated as a user, and has a weight and a distance. A data stream from a source may be transferred to a destination through the intermediate nodes. Each data stream uses the network bandwidth in accordance with its weight ratio.

The disclosed resource allocation utilizes a system benefit level to calculate the resource usage quantity of each user. According to a design, the resource residual quantity released from each user is normalized and then accumulated to a variable, called the system benefit level. When a user requires extra resources, the benefit quantity of the user is obtained by multiplying the cyclic increment of the system benefit level by a weight of the user. In an exemplary embodiment of the resource allocation, each user records a variable, called the individual benefit basis, and the user obtaining the resource usage right is responsible for calculating its own resource usage quantity, maintaining the system benefit level, and storing its individual benefit basis. In the calculation, the benefit quantity of an active user is equal to a product of the weight of the user and the difference between the system benefit level and the individual benefit basis of the user, wherein the individual benefit basis is the system benefit level stored by the user in the previous turn of obtaining the resource usage right. The steps of releasing the residual resources from a user includes dividing the residual quantity by an active weight sum, and accumulating the divided result to the system benefit level, wherein the active weight sum is a sum of the weights of the users currently having an active state.

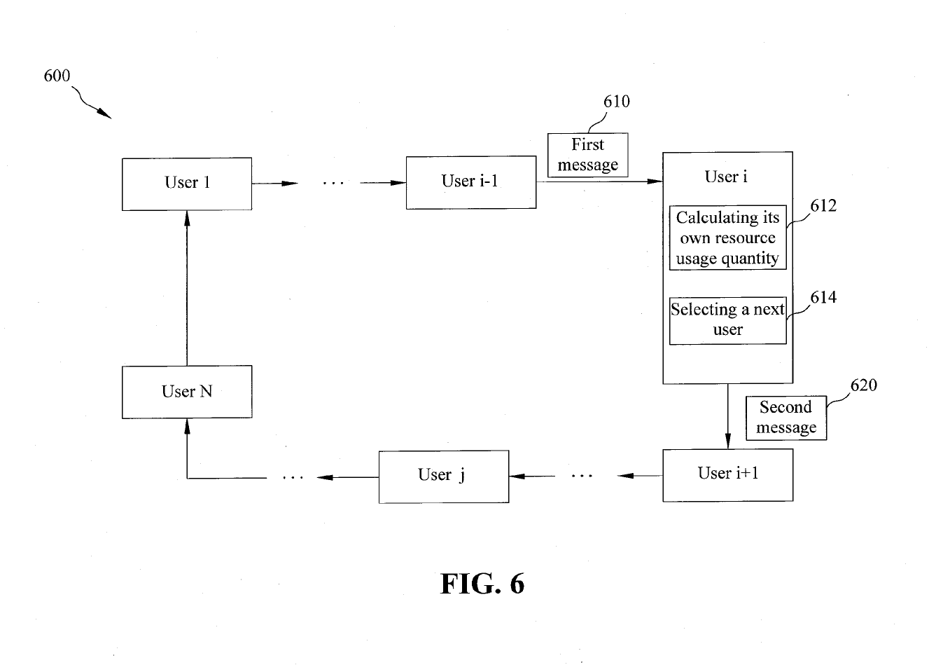

Accordingly, FIG. 6 shows an exemplary architecture for a resource allocation system applied in a distributed TDM system, according to an exemplary embodiment. Referring to FIG. 6, the resource allocation system 600 consists of a plurality of users, denoted by user 1 to user N, where N is the number of users. Each user takes turn to use resources of the distributed TDM system. Each user i, 1 ≦i≦N, has a corresponding weight wᵢ, and repeats the execution of: receiving a first message 610 to obtain a resource usage right, calculating a resource usage quantity 612 of the user, selecting a next user 614, and transmitting a second message 620 to transfer the resource usage right to the next user i+1, wherein when the resources used by user i reaches an amount of the resource usage quantity 612, the user i transmits the second message 620.

As mentioned above, the exemplary embodiments of the disclosure maintain a set of resource management variables in a memory to be taken for a reference of calculating the resource usage quantity. This set of resource management variables contains a set of public resource management variables, and a plurality of sets of private resource management variables with each corresponding to a user. The set of public resource management variables includes at least an active weight sum and a system benefit level, and is collaboratively maintained by all users. Each set of private resource management variables includes at least a user state and an individual benefit basis, and is maintained by the corresponding user. Accordingly, the first message 610 comprises an active weight sum and a system benefit level. The second message 620 comprises an updated active weight sum and an updated system benefit level. Each user may include a transceiver to receive the first message and to transmit the second message. Each user may comprise a computing device to calculate the resource usage quantity and the resource residual quantity of the user, to update the active weight sum, to store the individual benefit basis of the user, and to divide the resource residual quantity by the active weight sum and accumulate the divided result to the system benefit level.

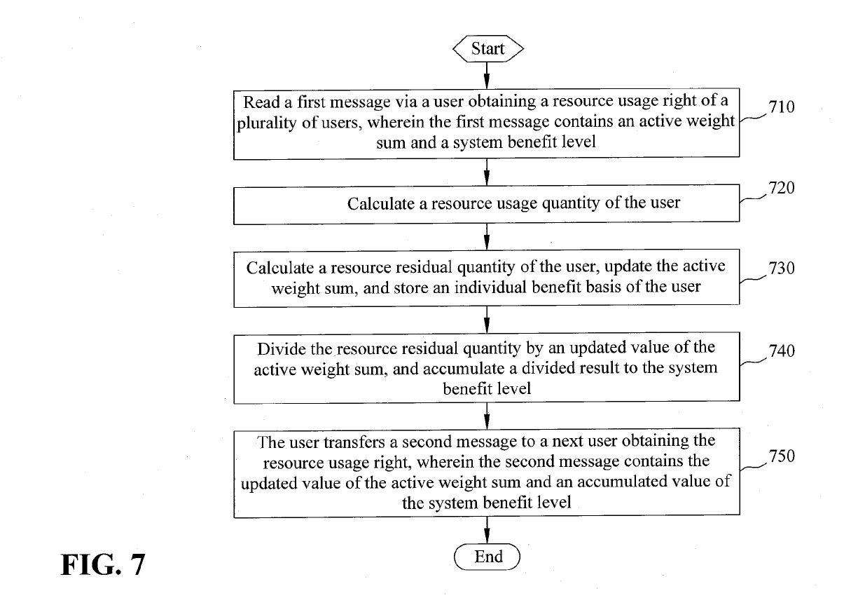

Based on this set of resource management variables, and combined with the resource allocation system 600, FIG. 7 shows the operation of a resource allocation method applied in a distributed TDM system, according to an exemplary embodiment. Herein, the user 1 to user N may take turns to use resources of the distributed TDM system.

Referring to FIG. 7, in step 710, first, this method reads a first message via a user obtaining a resource usage right of a plurality of users, wherein this first message contains an active weight sum and a system benefit level. Then, it calculates a resource usage quantity of the user, as shown in step 720. And it further calculates a resource residual quantity of the user, updates the active weight sum, and stores an individual benefit basis of the user, as shown in step 730. An alternative way for the action of updating the active weight sum is performing the updating action in step 720 instead of in step 730. In step 740, the method divides the resource residual quantity by an updated value of the active weight sum, and accumulates a divided result to the system benefit level. Then, the user transfers a second message to a next user obtaining the resource usage right, wherein the second message contains the updated value of the active weight sum and an accumulated value of the system benefit level, as shown in step 750. All of the above steps 710 to 750 are repeated to allocate resources of the system. Accordingly, each of the plurality of users may use the resources of the distributed TDM system.

As mentioned above, a user may be, for example, a data stream, a node, or a data queue corresponding to certain service level in a network, and may individually use the bandwidth of one or more channels within a dedicated time for data transmission. In addition, a user may be a software program, a thread, or a task, and may individually use the computational resources of one or more processing cores in a CPU within a dedicated time. The order for a user to obtain a resource usage right may be determined by a number of schemes, for example, dynamic adjustment according to any one combination of a predefined order, the weight of each user, the current state of each user, and the demand quantity of each user. All of the users may use the system resources in a round robin scheme.

After having calculated the resource usage quantity of the user (step 720), the resource allocation method stores a state of the user, as mentioned earlier. The definition of a user state may be flexibly designed according to application demands A definition of the user state may be a calculation result based on a demand quantity and a basic quantity of the user. For example, when the demand quantity is greater than the basic quantity, the user state is active, otherwise it is inactive. Another definition of the user state is a calculation result based on a demand quantity and any one combination of a basic quantity, a weight, an old state, an individual benefit basis, and a system benefit level. For example, when the demand quantity is greater than a value of the basic quantity+the weight×(the systems benefit level−the individual benefit basis), this user state is active; otherwise it is inactive. For each user, a new state stored after the (k−1)^{th} turn of resource allocation may be regarded as an old state before the k^{th} turn of resource allocation, wherein k is an index of turn.

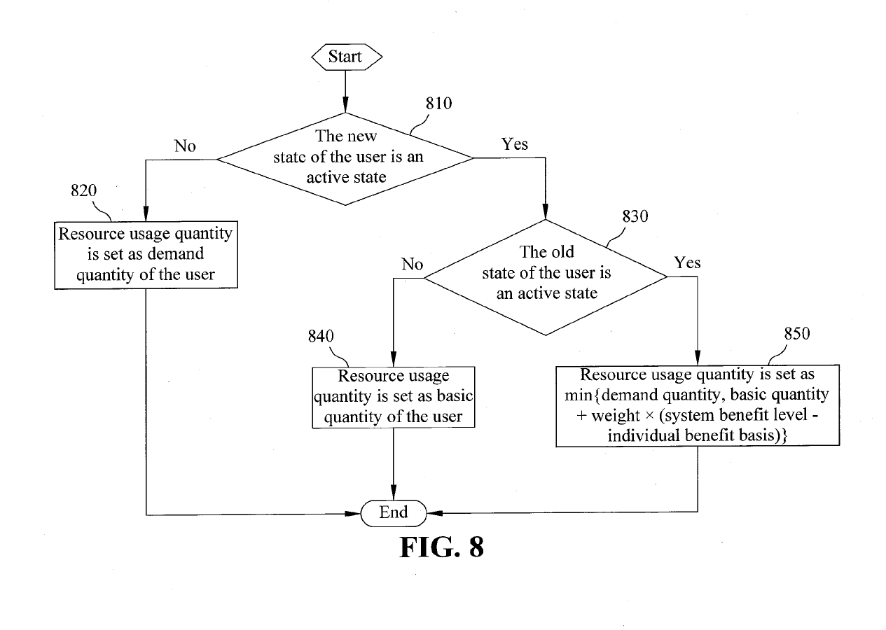

FIG. 8 shows a flow chart of calculating the resource usage quantity of a user, according to an exemplary embodiment. Referring to FIG. 8, in step 810, it checks whether the new state of the user is active. If the new state is inactive, the resource usage quantity is set as the demand quantity of the user, as shown in step 820. If the new state of the user is active, it further checks whether the old state of the user is active, as shown in step 830. If the old state is inactive, the resource usage quantity is set as the basic quantity of the user, as shown in step 840. If the old state of the user is active, the resource usage quantity is set as min{demand quantity, basic quantity+weight×(system benefit level−individual benefit basis)}, as shown in step 850. Wherein min is a function of minimum value.

It may be seen from the formula of calculating the resource usage quantity in step 850, the benefit quantity of an active user comes from a product of the weight of the user and the difference between the system benefit level and the individual benefit basis of the user, wherein the individual benefit basis is the system benefit level stored by the user in the previous turn of obtaining the resource usage right.

Accordingly, the disclosed resource allocation uses the system benefit level to calculate the resource usage quantity of the user. The principle behind is to extract the common items from the elements of benefit quantity obtained by each user in the procedure of allocating the residual resources. Then, define the system benefit level as the accumulated value of these common items, thus the sum of the common items in each benefit quantity of a user within a service cycle is equal to the difference of the system benefit level between this turn and the previous turn of obtaining the resource usage right. Finally, the difference of the system benefit level is multiplied by the weight of the user to serve as the benefit quantity for the user obtained in this turn of resource allocation.

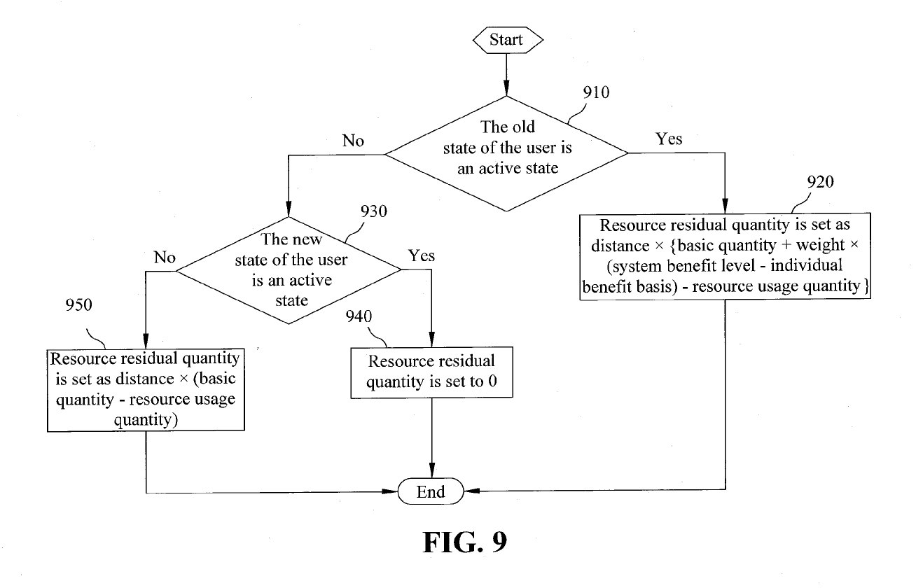

The disclosed resource allocation based on per-flow fairness arranges the transmission quantity of each data stream to conform to the weighted max-min fairness principle, under the condition of data forwarding. This application scenario takes each data stream as a user. Each data stream has a corresponding weight and a corresponding distance, and a data stream from a source node may be transferred through the intermediate nodes to a destination node. In the resource allocation based on per-flow fairness, each time when a data stream releases residual resources at a source node, an identical quantity of resources may be saved at each of the interfaces on the path. Therefore, the resource residual quantity is defined to be the product of the resource residual quantity at the source node and the distance of the data stream. FIG. 9 shows a flow chart of calculating a resource residual quantity of a user for the resource allocation based on per-flow fairness, according to an exemplary embodiment.

Referring to FIG. 9, in step 910, it checks whether the old state of the user is active. If it is, the resource residual quantity is set as distance×{basic quantity+weight×(system benefit level−individual benefit basis)−resource usage quantity}, as shown in step 920. If the old state of the user is inactive, it checks whether the new state of the user is active, as shown in step 930. If the new state is active, the resource residual quantity is set to 0, as shown in step 940. If the new state is inactive, the resource residual quantity is set as distance×(basic quantity−resource usage quantity), as shown in step 950.

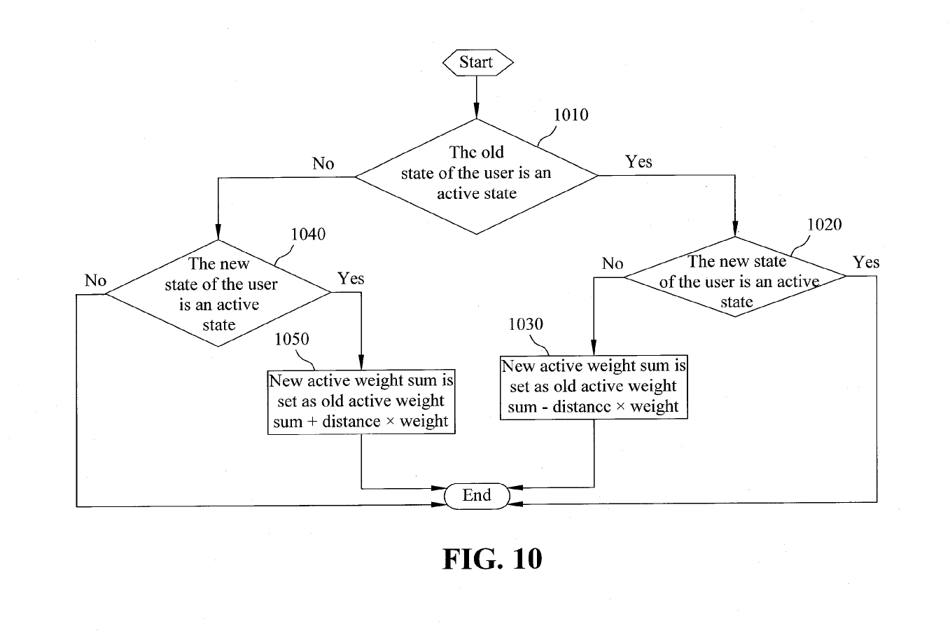

In addition, in the resource allocation based on per-flow fairness, the data stream with an active state may obtain a benefit quantity proportional to its weight at each of the interfaces on the path, so the active weight sum of the system is defined to be the sum of all active path weights, wherein an active path weight=weight of an active data stream×distance of the active data stream. FIG. 10 shows a flow chart of updating the active weight sum for the resource allocation based on per-flow fairness, according to an exemplary embodiment. Referring to FIG. 10, in step 1010, it checks whether the old state of the user is active. If it is, then in step 1020, it further checks whether the new state of the user is active. If the new state is inactive, the new active weight sum is set as the old active weight sum−distance×weight (of the user), as shown in step 1030. If the old state of the user is inactive, then in step 1040, it checks again whether the new state of the user is active. If the new state is active, the new active weight sum is set as the old active weight sum+distance×weight (of the user), as shown in step 1050. In other words, when the old state of the user is active and the new state is inactive, the new active weight sum is set as the old active weight sum−distance×weight; when the old state of the user is inactive and the new state is active, the new active weight sum is set as the old active weight sum+distance×weight. Represent the inactive state by 0 and the active state by 1 respectively, then the formula for updating an active weight sum may be expressed as follows:

new active weight sum=old active weight sum+distance×weight×(new state−old state).

Accordingly, the following illustrates an exemplar of resource allocation based on per-node fairness mode. First, a standard ruler is used as a basis of the resource allocation. Herein, a standard cyclic service amount is obtained by deducting overheads from a standard cyclic resource amount, and then a basic quantity for each user is determined according to the standard cyclic service amount, so that the sum of the basic quantities of all users is equal to the standard cyclic service amount. In the exemplary embodiments of the disclosure, the resource allocation defines the basic quantity of each user in accordance with a corresponding weight of the user. Wherein the standard cyclic service amount=standard cyclic resource amount−sum of overheads within one service cycle; basic quantity of a user=standard cyclic service amount×weight of the user/sum of weights of all users. In each service cycle, every user obtains a resource usage right in order, and requests a demand quantity of system resources. For each user, the old state and the individual benefit basis before a current turn of resource allocation are respectively identical to the new state and the individual benefit basis after the previous turn of resource allocation; the old active weight sum and the system benefit level before a resource allocation are respectively identical to the new active weight sum and the system benefit level after the resource allocation of the previous user. Based on the above-mentioned premises, the resource allocation procedure for each user based on per-node fairness mode may be described by the following resource management variables and operations.

benefit quantity←old state×weight×(system benefit level before allocation−individual benefit basis before allocation),

allocation quantity←basic quantity+benefit quantity,

usage quantity←min{demand quantity, allocation quantity},

residual quantity←allocation quantity−usage quantity,

new state←(demand quantity>basic quantity)?1:0,

new active weight sum←old active weight sum+weight×(new state−old state), in other words, the new active weight sum is updated as

the active weight sum read from the first message+the weight of the user×(new state−old state), wherein the active weight sum read from the first message has been mentioned in step 710 of FIG.7,

individual benefit basis after allocation←systems benefit level before allocation,

system benefit level after allocation←system benefit level before allocation+(residual quantity/new active weight sum).

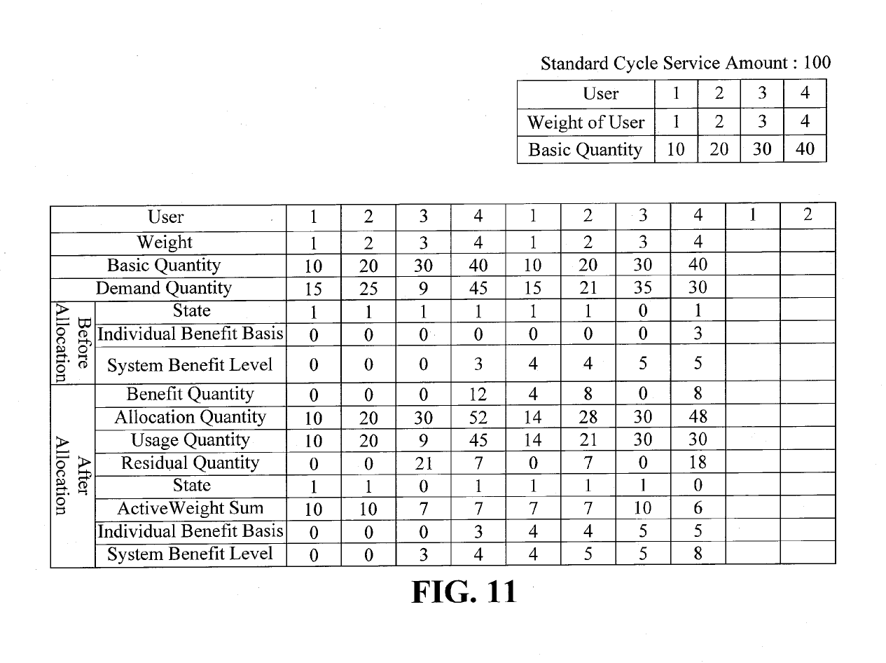

According to the above description, FIG. 11 shows a numerical exemplar of resource allocation based on per-node fairness mode, according to an exemplary embodiment. Referring to FIG. 11, based on the assumptions shown on the top right of the figure, the standard cyclic service amount is set to 100. Four users, said user 1, user 2, user 3, and user 4, share the system resources, and their weights are 1, 2, 3, and 4, respectively. Accordingly, the corresponding basic quantities of these four users are 10, 20, 30, and 40, respectively. Assume that all users are initially set in an active state (represented by 1), and thus the active weight sum is 10.

Take the resource allocation of the first cycle for user 4 as an example. For the user 4, the weight is 4, the basic quantity is 40, and the demand quantity in this turn is 45. According to the variables and operations mentioned above, the resource allocation may be described as follows.

benefit quantity=old state×weight×(system benefit level before allocation−individual benefit basis before allocation)=1×4×(3−0)=12,

allocation quantity=basic quantity+benefit quantity=40+12=52

usage quantity=min{demand quantity, allocation quantity}=min {45,52}=45,

residual quantity=allocation quantity−usage quantity=52−45=7,

Since the demand quantity is greater than the basic quantity, the new state=1,

new active weight sum=old active weight sum+weight×(new state−old state)=7+4×(1−1)=7,

individual benefit basis after allocation=systems benefit level before allocation=3,

system benefit level after allocation=system benefit level before allocation+(residual quantity/new active weight sum)=3+7/7=4.

Similarly, take the resource allocation of the second cycle for user 4 as an example. The demand quantity of user 4 in this turn is 30. Accordingly, benefit quantity=old state×weight×(system benefit level before allocation−individual benefit basis before allocation)=1×4×(5−3)=8; allocation quantity=basic quantity+benefit quantity=48; usage quantity=min{demand quantity, allocation quantity}=30; residual quantity=allocation quantity−usage quantity=18; since demand quantity is less than basic quantity, the new state=0; new active weight sum=old active weight sum+weight×(new state−old state)=10+4×(0−1)=6; individual benefit basis after allocation=systems benefit level before allocation=5; system benefit level after allocation=system benefit level before allocation+(residual quantity/new active weight sum)=5+18/6=8.

By analogy, the following illustrates an exemplar of resource allocation based on per-flow fairness mode. In the resource allocation based on per-flow fairness, the basic quantity of a data stream at each of the interfaces on the path is identical, thus the sum of products of all users' basic quantities and their corresponding distances is equal to the standard cyclic service quantity. In the disclosed exemplary embodiments of the resource allocation, basic quantity of a data stream=standard cyclic service quantity×weight of the data stream/sum of all path weights; wherein a path weight=weight of a data stream×distance of the data stream. Each time when a data stream releases residual resources at a source node, an identical quantity of resources may be saved at each of the interfaces on the path. Therefore, in the disclosed exemplary embodiments of the resource allocation, resource residual quantity of a data stream=resource residual quantity of the data stream at the source node×distance of the data stream. Furthermore, a data stream with an active state may obtain a benefit quantity proportional to its weight at each of the interfaces on the path. Therefore, in the disclosed exemplary embodiments of the resource allocation, an active weight sum is defined to be the sum of all active path weights, wherein an active path weight=weight of an active data stream×distance of the active data stream.

In the disclosed exemplary embodiments of the resource allocation, resource usage amount of an interface indicates the amount of resources supplied to all of the data streams passing through the interface, wherein these data streams include the data streams forwarded by this interface and the data streams generated at this interface. Each time when the usage quantity of a data stream differs from the basic quantity at a source node, an identical quantity of this difference will be accumulated to the resource usage progress offset at each of the interfaces on the path, therefore, new added progress offset=(basic quantity of a data stream−resource usage quantity of the data stream at a source node)×distance of the data stream.

Accordingly, the resource allocation procedure based on per-flow fairness mode may be described by the following resource management variables and operations.

benefit quantity←old state×weight×(system benefit level before allocation−individual benefit basis before allocation),

allocation quantity←basic quantity+benefit quantity,

usage quantity←min{demand quantity, allocation quantity},

interface usage amount←sum of the usage quantities of all streams forwarded by the interface+sum of the usage quantities of all streams generated at the interface,

residual quantity←distance×(allocation quantity−usage quantity),

new state←(demand quantity>basic quantity)?1:0,

new active weight sum←old active weight sum+distance×weight×(new state−old state), in other words, the new active weight sum is updated as

the active weight sum read from the first message+a distance of the user×the weight of the user×(new state−old state), wherein the active weight sum read from the first message has been mentioned in step 710 of FIG.7,

individual benefit basis after allocation←systems benefit level before allocation,

system benefit level after allocation←system benefit level before allocation+(residual quantity/new active weight sum).

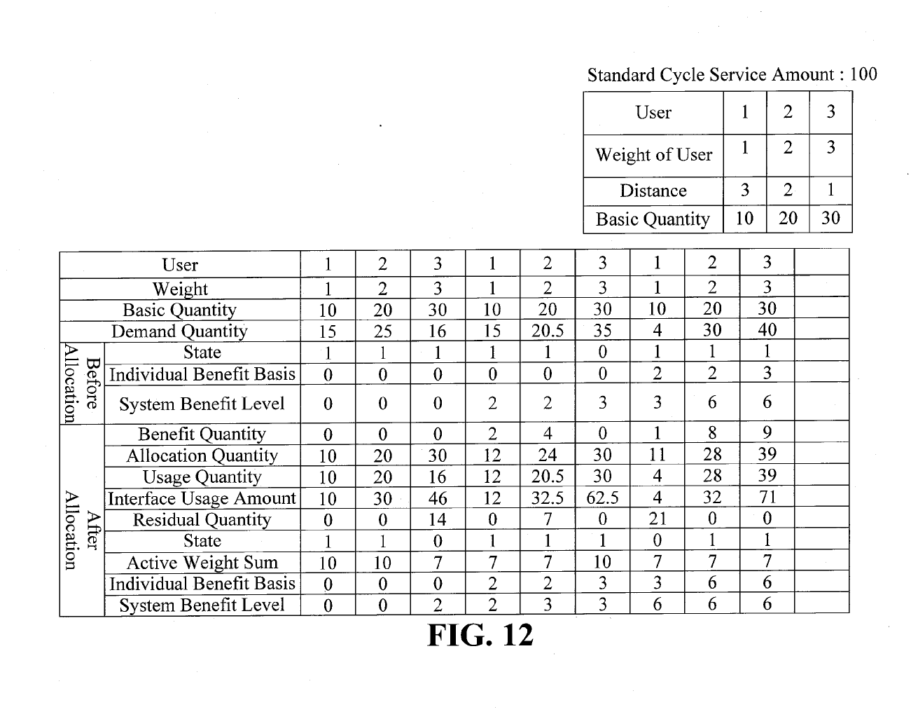

According to the above description, FIG. 12 shows a numerical exemplar of resource allocation based on per-flow fairness mode, according to an exemplary embodiment. In the exemplar of FIG. 12, the mesh network system in FIG. 5B is the premise of the application scenario. Assume that the standard cyclic service amount is set to 100 in the mesh network system of FIG. 5B. Three users, said user 1, user 2 and user 3, share the system uplink bandwidth, their weights are 1, 2 and 3, and their path lengths are 3, 2 and 1, respectively. Accordingly, the basic quantity corresponding to the three users are 10, 20, and 30, respectively. Assume that all users are initially set in an active state (represented by 1), and thus the active weight sum is 10 (i.e. sum of the products of each user's weight and its distance).

Referring to FIG. 12, take the resource allocation of the first cycle for user 3 as an example. For the user 3, the weight is 3, the basic quantity is 30, and the demand quantity in this turn is 16. According to the variables and options mentioned above, the resource allocation may be described as follows.

benefit quantity=old state×weight×(system benefit level before allocation−individual benefit basis before allocation)=1×3×(0−0)=0,

allocation quantity=basic quantity+benefit quantity=30+0=30,

usage quantity=min{demand quantity, allocation quantity}=min{16, 30}=16,

interface usage amount=sum of the usage quantities of all streams forwarded by the interface+sum of the usage quantities of all streams generated at the interface=30+16=46,

residual quantity=distance×(allocation quantity−usage quantity)=1×(30−16)=14,

Since the demand quantity is less than the basic quantity, the new state=0,

new active weight sum=old active weight sum+distance×weight×(new state−old state)=10+1×3×(0−1)=7,

individual benefit basis after allocation=systems benefit level before allocation=0,

system benefit level after allocation=system benefit level before allocation+(residual quantity/new active weight sum)=0+14/7=2.

Similarly, take the resource allocation of the third cycle for user 1 as an example. For the user 1, the weight is 1, the basic quantity is 10, and the demand quantity in this turn is 4. Accordingly, benefit quantity=old state×weight×(systems benefit level before allocation−individual benefit basis before allocation)=1×1×(3−2)=1; allocation quantity=basic quantity+benefit quantity=11; usage quantity=min{demand quantity, allocation quantity}=4; interface usage amount=sum of the usage quantities of all the forwarded streams+sum of the usage quantities of all the generated streams=0+4=4; residual quantity=distance×(allocation quantity−usage quantity)=3×(11−4)=21; since demand quantity is less than basic quantity, the new state=0; new active weight sum=old active weight sum+distance×weight×(new state−old state)=10+3×1×(0−1)=7; individual benefit basis after allocation=system benefit level before allocation=3; system benefit level after allocation=system benefit level before allocation+(residual quantity/new active weight sum)=3+21/7=6.

Therefore, according to the disclosed exemplary embodiments of the resource allocation, under either the per-node fairness mode or the per-flow fairness mode, calculating the resource usage quantity for each user within one service cycle may have a very low computational complexity. In other words, the required computation amount reduced to a constant, which is independent of the user number in the system.

In the disclosed exemplary embodiments, the resource allocation controls the progress offset of an actual resource usage relative to the standard ruler by limiting the range of resource usage quantity of each user, so as to guarantee the maximum latency of waiting for resources for each user. In the resource allocation based on per-flow fairness, a new added progress offset of a data stream is less than or equal to an allowed incremental progress offset, wherein the new added progress offset of a data stream=(basic quantity of the data stream−resource usage quantity of the data stream at a source node)×distance of the data stream, and the allowed incremental progress offset=maximum progress offset−current progress offset. Accordingly, the resource usage quantity of a data stream at a source node basic quantity of the data stream−(maximum progress offset−current progress offset)/distance of the data stream. Wherein, when the resource usage right is transferred from a data stream A to a data stream B, current progress offset of data stream B=current progress offset of data stream A+(basic quantity of data stream B−resource usage quantity of data stream B at source node)×distance of data stream B.

In the disclosed exemplary embodiments, the resource allocation calculates the resource usage quantity of each user according to a set of public resource management variables transferred among users. This may increase the flexibility of network topology, and reduce the computation amount of resource allocation. For example, the residual resources released from users are immediately reallocated to all users in a network according to a weight ratio by simply maintaining the states of the set of public resource management variables at the user obtaining a resource usage right, instead of broadcasting the resource residual quantity to all users in the network. Besides, the set of public resource management variables, such as W, B, L, are simplified to reduce the overhead of transferring message, where W is the active weight sum, B is the system benefit level, and L is the progress offset. Herein the number of public resource management variables is independent of the number of users.

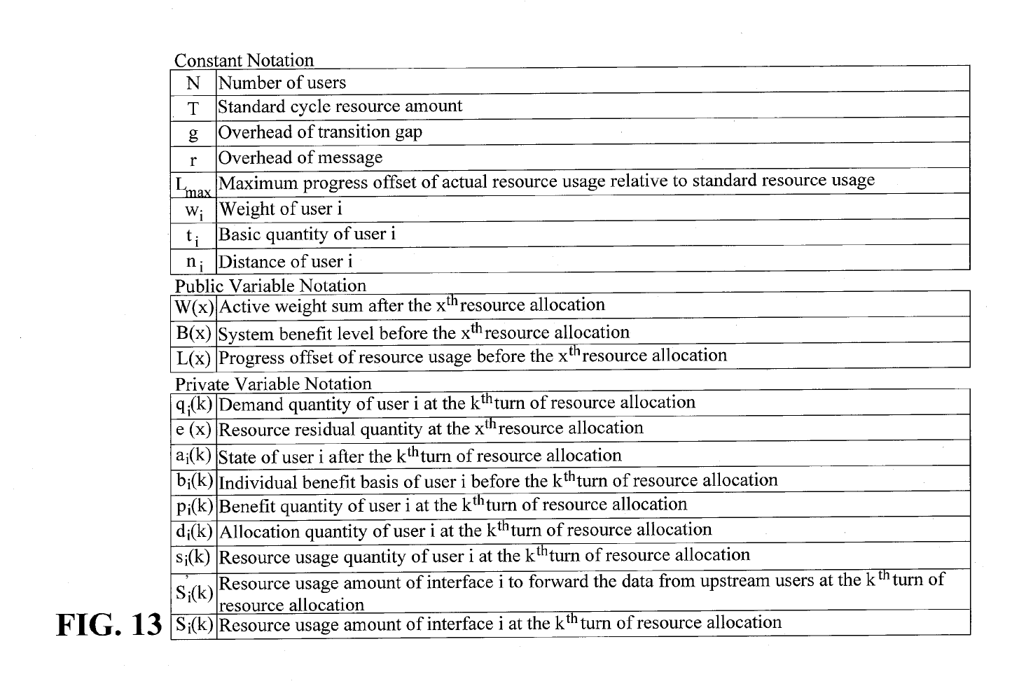

The disclosed exemplary embodiments define some constant notations and some variable notations to express the physical quantities and the procedures of resource allocation. FIG. 13 shows an exemplar for a definition of constant notations and variable notations, according to an exemplary embodiment. It may be seen from FIG. 13, the resource management variables are served as a reference for calculating the resource usage quantity of each user. Also, according to these physical quantities and procedures of the resource allocation, it may also be seen that when a user releases residual resources, the resource residual quantity is normalized and accumulated to a resource management variable (i.e., system benefit level); when a user requires extra resources, the benefit quantity is derived from a product of the cyclic increment of the resource management variable and a weight of the user. It may also be learned from the aforementioned operation flows that each user who obtains the resource usage right is responsible for calculating its own resource usage quantity in the present service cycle, and maintaining the status of this set of public resource management variables collaboratively.

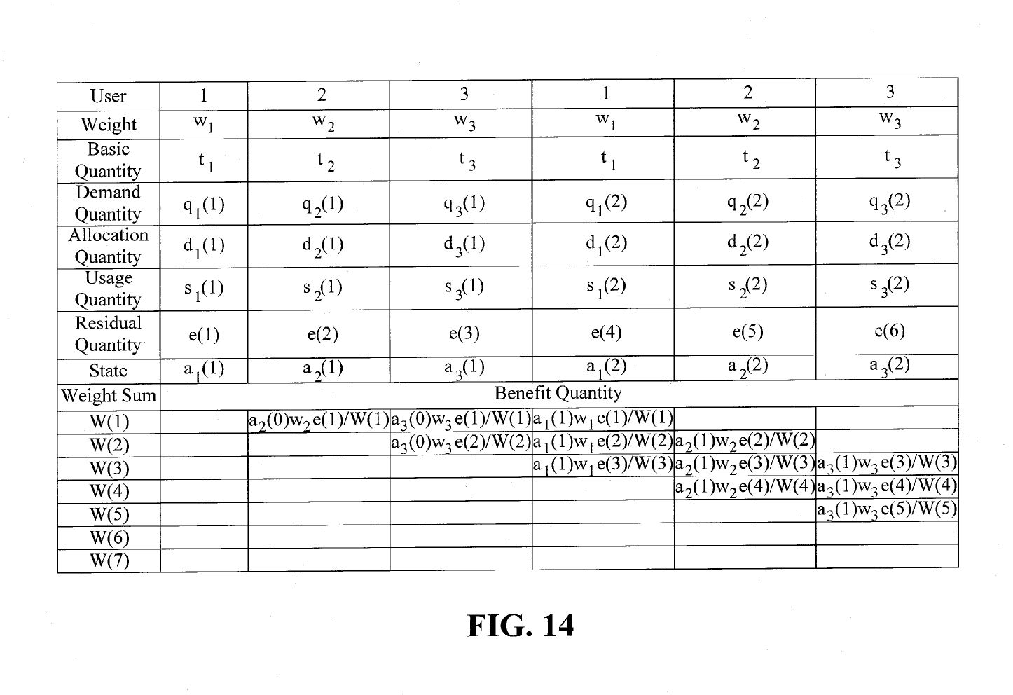

FIG. 14 shows an exemplar of calculating the resource usage quantity of each user through the notations defined in FIG. 13, according to an exemplary embodiment. It may be seen from FIG. 14 that the benefit quantities of any two successive users within one service cycle are composed of a plurality of common items e(x)/W(x), where e(x) and W(x) respectively represent the residual quantity and the active weight sum after the x^{th} resource allocation in the system. Furthermore, the system benefit level B(x) may be defined as follows:

B(x)=Σ^{x}ᵤ₌₁{e(u)/W(u)}.

Accordingly, for a user having an active state, the sum of the common items e(x)/W(x) in the benefit quantity of the user accumulated within one service cycle is equal to the difference of system benefit level between this turn and the previous turn of resource allocation, that is B(x)−B(x−N), where N is the number of users, B(x) is the system benefit level before this turn of resource allocation, and B(x−N) is the system benefit level before the previous turn of resource allocation, which may be the individual benefit basis stored after the previous turn of resource allocation. For example, the sum of the common items in the benefit quantity of user 3 in the second service cycle is B(5)−B(2). Then, the benefit quantity of the user accumulated within one service cycle is obtained by multiplying the difference of system benefit level by the weight of the user.

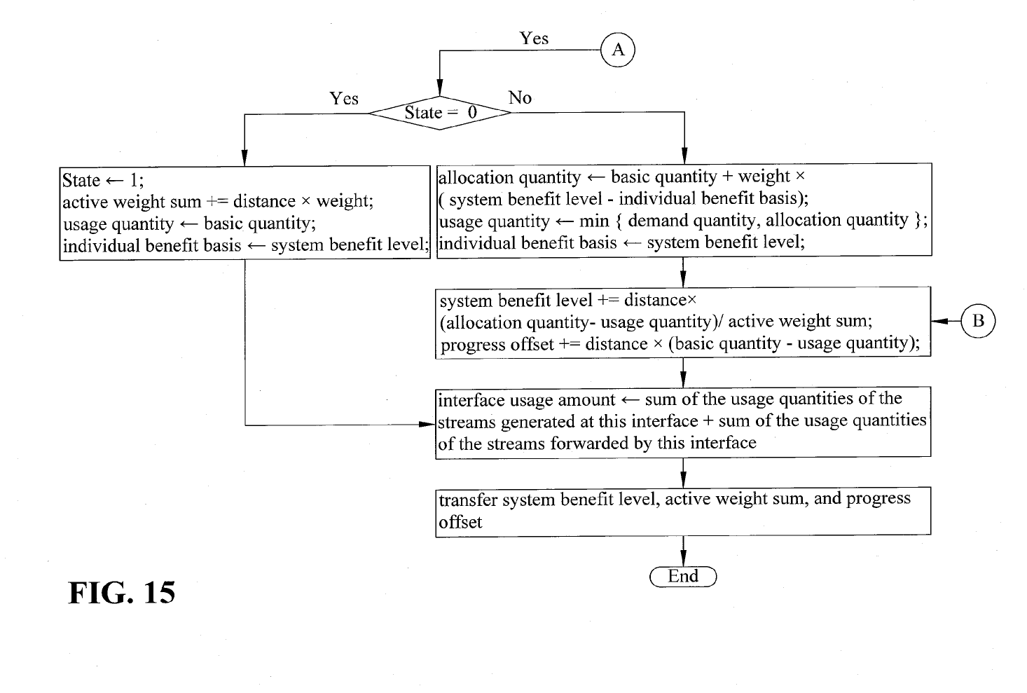

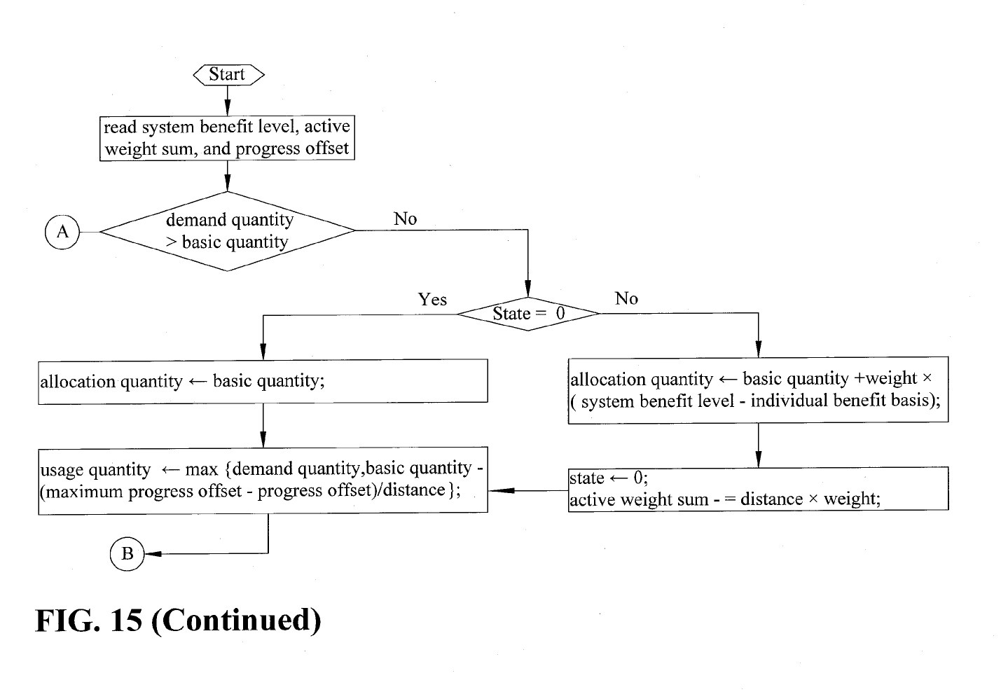

The above mentioned resource allocation in conformity with the weighted max-min fairness principle, the control of resource usage progress offset, the resource allocation based on per-node fairness mode, and the resource allocation based on per-flow fairness mode may be furthermore integrated into a simplified resource allocation procedure. FIG. 15 shows a resource allocation procedure expressed by the physical quantities and operations with consideration of a progress offset limit of the resource usage, according to an exemplary embodiment. Wherein the details of allocating resource residual quantity according to a weight ratio, controlling the progress offset of resource usage, and resource allocation procedures based on per-node and per-flow fairness modes may refer to the above descriptions. Therefore, the operation steps in FIG. 15 are not repeated.

In summary, the exemplary embodiments of the present disclosure may provide a method and system for resource allocation in distributed time-division multiplexing (TDM) systems. By limiting the switching frequency of resource usage, the overhead of resource allocation is reduced, so as to improve the system resource utilization. Concurrently, limiting the switching frequency prevents users from continuously monitoring and transferring messages, so that the power consumption of the transceivers is reduced. Also, this limitation reduces the probability of packet loss and occurrence of network reconstruction, thereby enhancing the system stability. By reallocating the resource residual quantity according to a weight ratio of active users, the max−min fairness principle for resource allocation is conformed to, and the minimum resource usage quantity for each user is guaranteed. By controlling the progress offset of resource usage, the maximum latency each user waiting for resources is bounded. By transferring a set of public resource management variables among users, residual resources are immediately reallocated to all users in a distributed system with high flexibility of network topology. By simplifying the set of public resource management variables, the maintenance cost of message fields is decreased to an order independent of user number. Moreover, the exemplary embodiments provide a simplified scheme of calculating the resource usage quantity based on system benefit level, which reduces the computational complexity of resource allocation.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for resource allocation in a distributed time-division multiplexing (TDM) system, the distributed TDM system consisting of one or more resources and a plurality of users with each user having a weight, the method comprising:
reading a first message via a user obtaining a resource usage right of the plurality of users, wherein the first message containing an active weight sum and a system benefit level;
calculating a resource usage quantity of the user, calculating a resource residual quantity of the user, updating the active weight sum, and storing an individual benefit basis of the user;
dividing the resource residual quantity by an updated value of the active weight sum and accumulating a divided result to the system benefit level;
transferring a second message containing the updated value of the active weight sum and an accumulated value of the system benefit level to a next user obtaining the resource usage right; and
repeating the above all steps to allocate resources of the distributed TDM system.

2. The method as claimed in claim 1, wherein each of the plurality of users is selected from a data stream, a node, or a data queue corresponding to a specific service level in a network, and uses a bandwidth of one or more channels within a dedicated time for data transmission.

3. The method as claimed in claim 1, wherein each of the plurality of users is selected from a software program, a thread, or a task, and uses computational resources of one or more processing cores in a central processing unit within a dedicated time.

4. The method as claimed in claim 1, wherein determining an order for each of the plurality of users to obtain the resource usage right has a plurality of schemes, at least including dynamic adjustment according to any one combination of a predefined order, the weight of the each user, a current state of the each user, and a demand quantity of the each user.

5. The method as claimed in claim 4, wherein the order of the plurality of users using the resources of the distributed TDM system is based on a round robin scheme.

6. The method as claimed in claim 2, wherein when each of the plurality of users is the node, or the data queue corresponding to the specific service level in the network, the resource usage quantity of the each user conforms to a weighted max-min fairness principle.

7. The method as claimed in claim 2, wherein when each of the plurality of users is the data stream, the resource usage quantity of the each user conforms to a weighted max-min fairness principle.

8. The method as claimed in claim 1, wherein a basic quantity of each of the plurality of users is determined according to a standard cyclic service amount that is available to the plurality of users in a standard cyclic resource amount, so that a sum of products of the basic quantity and a distance of the each user is equal to the standard cyclic service amount, wherein the distance of the each user is a positive integer.

9. The method as claimed in claim 8, wherein the basic quantity of each of the plurality of users is proportional to the weight of the user.

10. The method as claimed in claim 8, further includes:
storing a new state of the user, wherein the new state is a calculation result based on a demand quantity of the user and the basic quantity of the user, and taking a stored new state of the user in a previous turn of resource allocation as an old state of the user before a current turn of resource allocation, wherein the new state is one of an active state and an inactive state, and the old state is also one of the active state and the inactive state.

11. The method as claimed in claim 10, wherein the new state is a calculation result based on the demand quantity of the user and any one combination of the basic quantity of the user, the weight of the user, the old state of the user, the individual benefit basis of the user, and the system benefit level.

12. The method as claimed in claim 10, wherein when the demand quantity of the user in the current turn of resource allocation is greater than the basic quantity of the user, the new state of the user is the active state, otherwise is the inactive state.

13. The method as claimed in claim 10, wherein the resource usage quantity of the user is a calculation result of any one combination of according to the weight of the user, according to the demand quantity of the user, according to the basic quantity of the user, according to the old state of the users, according to the new state of the user, according to the individual benefit basis of the user, and according to the system benefit level.

14. The method as claimed in claim 13, wherein when the new state of the user is the inactive state, the resource usage quantity of the user is the demand quantity of the user.

15. The method as claimed in claim 13, wherein when the new state of the user is the active state and the old state of the user is the inactivate state, the resource usage quantity of the user is the basic quantity of the user.

16. The method as claimed in claim 13, wherein when the new state and the old state of the user are both the active state, the resource usage quantity of the user is
min{the demand quantity of the user, the basic quantity of the user+the weight of the user×(the system benefit level−the individual benefit basis of the user)}, wherein min is a minimum function.

17. The method as claimed in claim 10, wherein the resource residual quantity of the user is a calculation result of any one combination of according to the weight of the user, according to the basic quantity of the user, according to the old state of the user, according to the new state of the user, according to the individual benefit basis of the user, according to the resource usage quantity of the user, according to a distance of the user and according to the system benefit level, wherein the distance of the user is a positive integer.

18. The method as claimed in claim 17, wherein when the old state of the user is the active state, the resource residual quantity of the user is
the distance of the user×{the basic quantity of the user+the weight of the user×(the system benefit level−the individual benefit basis of the user)−the resource usage quantity of the user}.

19. The method as claimed in claim 17, wherein when the old state and the new state of the user are both the inactive state, the resource residual quantity of the user is
the distance of the user×(the basic quantity of the user−the resource usage quantity of the user).

20. The method as claimed in claim 17, wherein when the old state of the user is the inactive state and the new state of the user is the active state, the resource residual quantity of the user is zero.

21. The method as claimed in claim 10, wherein when the old state of the user is the inactive state and the new state of the user is the active state, the active weight sum is updated as
the active weight sum read from the first message+a distance of the user×the weight of the user, wherein the distance of the user is a positive integer.

22. The method as claimed in claim 10, wherein when the old state of the user is the active state and the new state of the user is the inactive state, the active weight sum is updated as
the active weight sum read from the first message−a distance of the user×the weight of the user, wherein the distance of the user is a positive integer.

23. The method as claimed in claim 1, wherein a stored value of the individual benefit basis of the user is the system benefit level that the user reads from the first message.

24. The method as claimed in claim 8, wherein the method further includes updating a progress offset included in the first message by using at least the progress offset of the first message, the basic quantity of the user, the resource usage quantity of the user, and a distance of the user, and the second message further comprises an updated progress offset, wherein the distance of the user is a positive integer.

25. The method as claimed in claim 24, wherein the progress offset is updated as
the progress offset of the first message+(the basic quantity of the user−the resource usage quantity of the user)×the distance of the user.

26. The method as claimed in claim 24, wherein the method further includes limiting the resource usage quantity of each of the plurality of users to control the progress offset in a range smaller than or equal to a maximum progress offset.

27. The method as claimed in claim 26, wherein the method limits the resource usage quantity of each of the plurality of users to be greater than or equal to
the basic quantity of the user−(the maximum progress offset−the progress offset of the first message)÷the distance of the user.

28. The method as claimed in claim 10, wherein before calculating the resource usage quantity of the user, the method further includes:
calculating an allocation quantity of the user, and the allocation quantity is a calculation result of any one combination of according to the basic quantity of the user, according to the weight of the user, according to the old state of the user, according to the individual benefit basis of the user, and according to the system benefit level.

29. A system for resource allocation in a distributed time-division multiplexing (TDM) system, wherein the system for resource allocation comprises a plurality of users with each user having a weight and taking turns to use resources of the distributed TDM system, and the each user repeats the execution of:
obtaining a resource usage right, and reading a first message of a user having an active weight sum and a system benefit level;
computing a resource usage quantity of the user, computing a resource residual quantity of the user, updating the active weight sum, and storing an individual benefit basis of the user;
dividing the resource residual quantity by an updated value of the active weight sum and accumulating a divided value of the resource residual quantity to the system benefit level; and
transferring a second message having the updated value of the active weight sum and an accumulated value of the system benefit level to a next user obtaining the resource usage right.

30. The system as claimed in claim 29, wherein each of the plurality of users comprises a transceiver to read the first message and transfer the second message.

31. The system as claimed in claim 29, wherein each of the plurality of users comprises a calculation device to calculate the resource usage quantity and the resource residual quantity of the user, update the active weight sum, store the individual benefit basis of the user, divide the resource residual quantity by the updated value of the active weight sum, and accumulate the divided value of the resource residual quantity to the system benefit level.

32. The system as claimed in claim 29, wherein each of the plurality of users is selected from a data stream, a node, or a data queue corresponding to a specific service level in a network, and uses a bandwidth of one or more channels within a dedicated time for data transmission.

33. The system as claimed in claim 29, wherein each of the plurality of users is selected from a software program, a thread, or a task, and uses computational resources of one or more processing cores in a central processing unit within a dedicated time.

34. The system as claimed in claim 29, wherein the system maintains a set of resource management variables in at least a memory, and the set of resource management variables serve as a reference of the resource allocation.

35. The system as claimed in claim 34, wherein the set of resource management variables comprises a set of public resource management variables, and the set of public resource management variables include at least the active weight sum and the system benefit level.

36. The system as claimed in claim 34, wherein for each of the plurality of users, the set of resource management variables comprises a set of corresponding private resource management variables, and the set of corresponding private resource management variables include at least a state of the user and the individual benefit basis of the user.

37. The system as claimed in claim 35, the system transfers the set of public resource management variables, wherein the set of public resource management variables further comprises a progress offset.
